(19) United States
(12) Patent Application Publication
(10) Pub. No.: US 2002/0079220 A1
(43) Pub. Date: Jun. 27, 2002

(54) Micromachining using printing technology

(76) Inventor: Janusz B. Pawliszyn, Waterloo (CA)

Correspondence Address: DARYL W SCHNURR, BARRISTER & SOLICITOR, PO BOX 2607, 18 WEBER STREEST WEST, KITCHENER, ONTARIO, N2H 6N2, CA

(21) Appl. No.: 09/986,489

(22) Filed: Nov. 9, 2001

Related U.S. Application Data
(60) Provisional application No. 60/246,699, filed on Nov. 9, 2000.

(51) Int. Cl. G01N 27/26; G01N 27/447

(52) U.S. Cl. 204/451; 204/453; 204/455; 204/601; 204/603; 204/605; 204/548; 204/610; 204/644; 101/114; 101/129; 101/483; 101/494; 347/101; 347/105; 347/107

(57) ABSTRACT

A microchannel that can be used for separating two or more substances present in a sample has a first substrate and a second substrate with printed component printed on one or both of the substrates and is shaped to define a perimeter of the channel. The substrates are affixed to one another so that the component is sandwiched between the substrates and is in contact with both substrates. The microchannel is constructed using printing techniques to define the channel on one or both of the substrates.

### BACKGROUND OF THE INVENTION

2. Field of Invention

This invention relates to microchannels used to separate two or more substances present in a sample and to a method of construction thereof. More particularly, this invention relates to a microchannel formed on a substrate by printing a component onto the substrate in the shape of a perimeter of the channel.

2. Description of the Prior Art

It is known to micro-fabricate analytical devices that are used for isoelectric focusing and other separation techniques. Microchannels have been fabricated on a quartz chip using photolithography and chemical etching, as described in a paper by Mao et al (Analyst, 1999, 124, 637-641 entitled Demonstration of isolectric focusing on an etched quartz chip with UV absorption imaging detection). This method of micro-fabrication can provide resolution down to one micrometer, but is often time consuming and/or expensive.

Screen printing has been used to apply prepolymeric inks through a pattern screen or stencil onto a suitable substrate for the mass production of inexpensive electrodes and electrochemical cells and this process can provide a resolution of 100 micrometers. This process has been used for the mass production of sensors for medical and environmental applications. See Wring et 11 Analytical Chemistry, 1990, 62, 203-212 and Frew et al Analytical Chemistry, 1997, 69, 933A-944A.

The separation typically involves electroosmetic flow driven separations such as Capillary Electrophoresis (CE) or Capillary Electrochromatography (CEC). The separation is performed in small channels embedded in planar substrates made of various materials including glass, quartz chips or plastic blocks. The channels are etched into glass or quartz chips and manufactured into plastic blocks. Etching is labor intensive and plastic manufacturing can give rise to difficulties in optical detection since the plastic materials are opaque at short UV wavelengths. Both are relatively expensive.

Capillary isoelectric focusing (CIEF) is a unique steady-state type of capillary electrophoresis in which amphoteric analytes are separated according to their different isoelectric points (pIs). CIEF that is conducted in common CE instruments usually employs a 20-60 cm long capillary and a single-point, on column detector. The analytes that are mixed with proper pH range and concentration of carrier ampholytes, injected into the separation capillary and focused at a corresponding position along the capillary under high DC electric field. After focusing, the analytes are mobilized and detected as they pass through the detection point. There are three main types of mobilization: electrophoretic, hydrodynamic, and electroosmotic mobilization. However, all mobilization methods interrupt the steady state of IEF, lengthen analysis time, and lead to uneven resolution along the separation column (i.e. 5 cm long). With the development of the whole column detection CIEF technique, the complete analysis of an amphoteric sample can be reduced to 2-6 minutes without the necessity of mobilization, and the isoelectric points of the amphoteric compounds can be directly determined by their positions along the capillary with the help of pI markers. In addition, ampholyte-free focusing of proteins can be accomplished in tapered channels by using buffers characterized by high temperature coefficient of pH. See J. Pawliszyn, U.S. Pat. No. 5,759,370.

### SUMMARY OF THE INVENTION

It is an object of the present invention to provide a micro-fabrication technique that is less time consuming and/or less expensive than previous techniques to construct a microchannel that is suitable for use in isoelectric focusing and other separation procedures.

A microchannel for use for separating two or more substances present in a sample has a first substrate with component printed thereon in a shape to define a perimeter of the channel. There is no etching or photolithography required.

Preferably, there is a first substrate and a second substrate with component printed on at least one of the substrates in a shape to define a perimeter of the channel. The substrates are fixed to one another so that the component is sandwiched between the substrates and is in sealing contact with both substrates.

A method of constructing a microchannel that is suitable for use in separating two or more substances present in a sample has a channel with a first substrate. The method comprises cleaning the substrate, printing a channel on the first substrate using printing techniques by depositing a printed component in the shape of a perimeter of the channel on the first substrate and curing the substrate.

Preferably, there is a first substrate and a second substrate and the method includes affixing the substrates to one another with the printed component sandwiched in between the substrates.

### BRIEF DESCRIPTION OF THE DRAWINGS

FIG. 1A is a top view of a microchannel;

FIG. 1B is a top view of a microchannel having a side entrance at each end;

FIG. 1C is a top view of a tapered channel;

FIG. 2 is a schematic exploded perspective view of a micro channel;

FIG. 3 is a top view of a microchannel that is set up for use for isoelectric focusing;

FIG. 4 is a schematic view of the set up for isoelectric focusing using absorption imaging with a microchannel;

FIG. 5 is a graph showing the electropherograms obtained from the dynamic focusing of four small molecular mass pI markers;

FIG. 6 shows the electropherograms obtained from the dynamic focusing of hemoglobin A and hemoglobin A₂;

FIG. 7 shows the electropherograms obtained by focusing 500 μg/ml (a) and 250 μg/ml (b) of hemoglobin A, A₂ standard under an electric field of 385 V/cm.

FIG. 8 shows the electropherograms obtained from the dynamic focusing of 250 μg/ml cat hemoglobin in Tris-HCl buffers using tapered channels.

### DESCRIPTION OF A PREFERRED EMBODIMENT

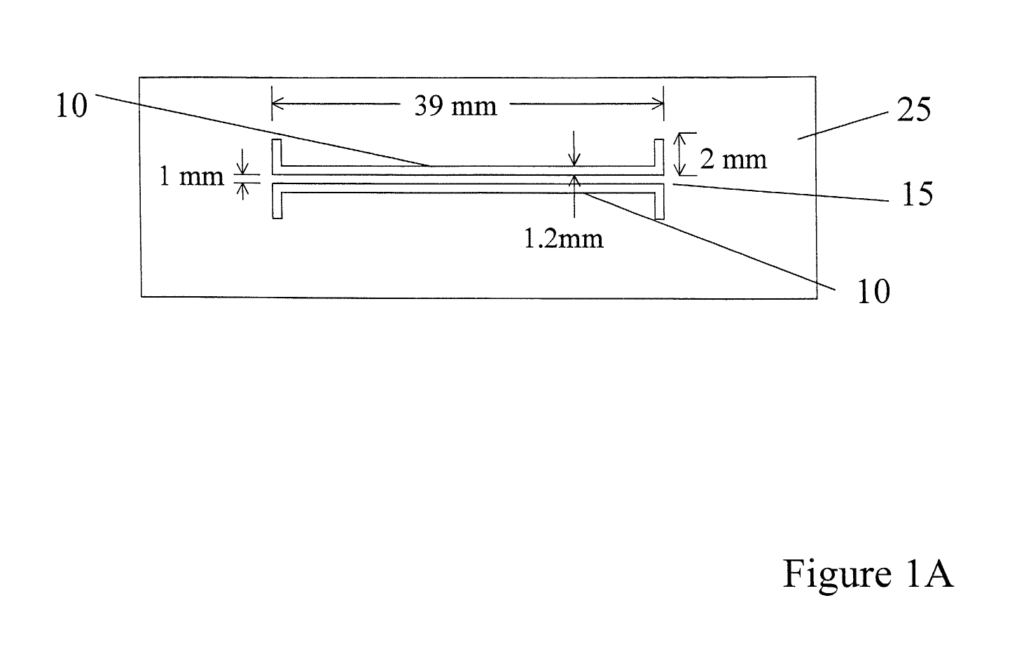

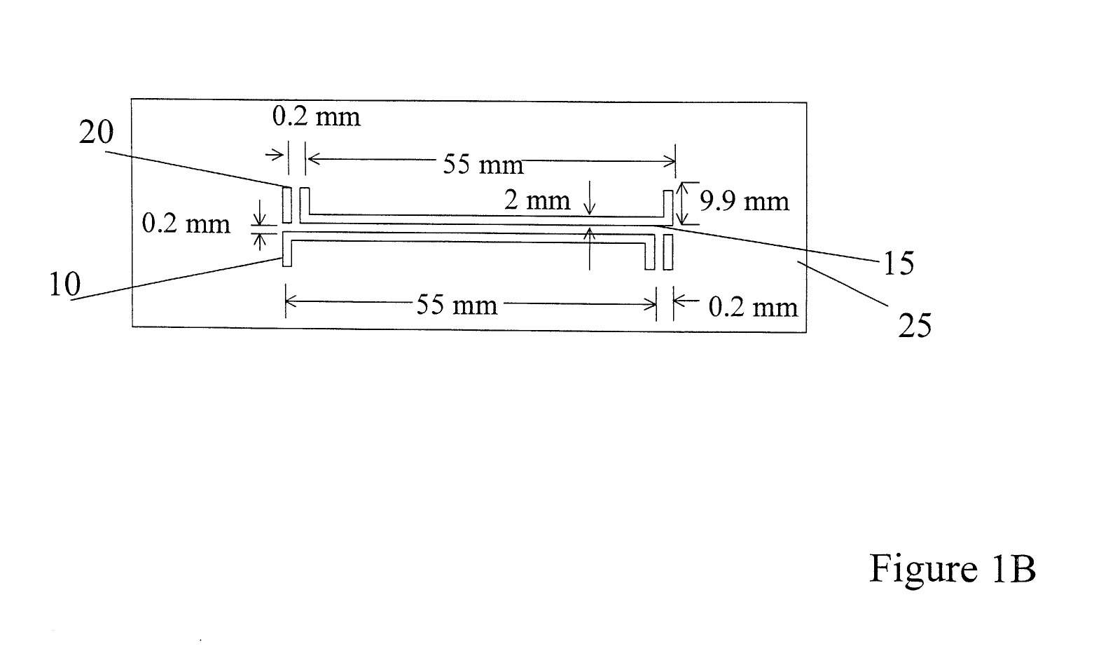

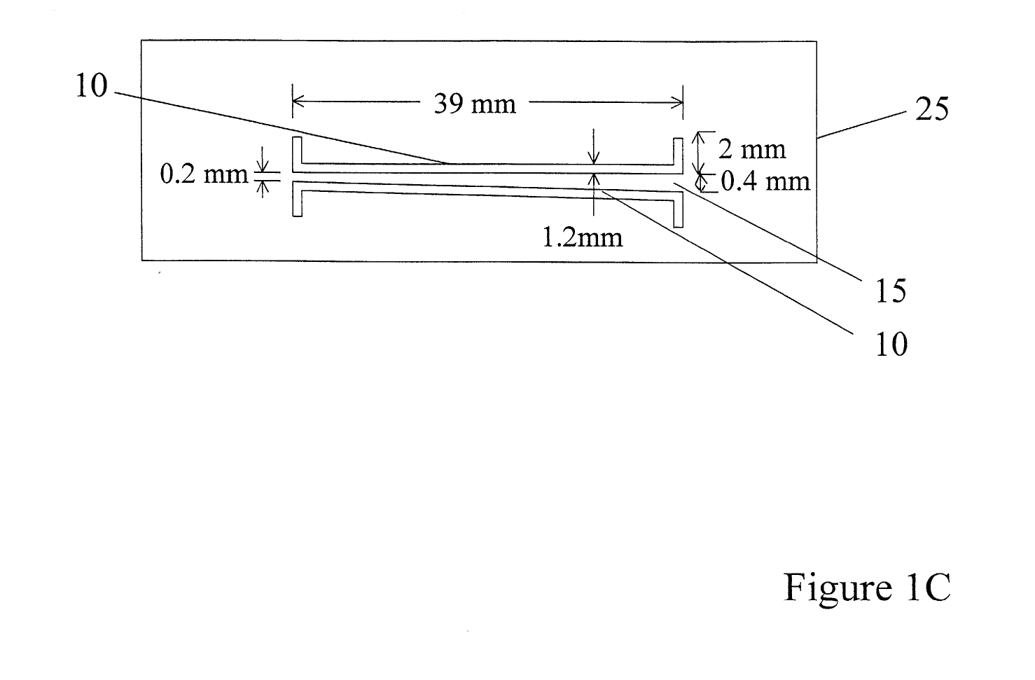

In FIG. 1A, there is shown two parallel lines 10 of printed component or “ink” that has been printed onto a substrate 25 to form a channel 15. The dimensions of the channel 15 are shown on the drawing. The printed component can vary in width and thickness (i.e. depth) by adjusting the printing technique being utilized. The lines 10 form a perimeter of the channel 15.

In FIG. 1B, the lines 10 of printed component are deposited on the substrate 25 to define a channel 15. However, the lines 10 are laid out slightly differently from the lines 10 in FIG. 1A as the channel 15 in FIG. 1B has a side entrance 20 at each end thereof. The side entrance can be used to inject sample into the channel 15. The design shown in FIG. 1B allows the sample introduction to be independent of the electrolyte vials that are placed in contact with the ends of the channel during isoelectric focusing.

In FIG. 1C, the lines 10 are tapered to define a channel 15 on the substrate 25. Since the channels in FIGS. 1A, 1B and 1C are printed onto the substrate 25 using known print technology, it can be appreciated that various shapes and thicknesses of the channel can be easily accomplished. More complicated structures than those shown can be designed and printed without difficulty. The thickness of the channel is dependant on the amount of printed component used as well as the particular type of printing technology that is used to deposit the component on to the substrate. For example, ink jet printing can be utilized or thick film printing techniques such as screen printing can be employed. The viscosity of the printed component is critical. If the viscosity is too low, strip widening may occur after the line is printed on to the substrate. If the viscosity is too high or if the ink contains particulates, uneven or marked edges may result.

The thickness of the printed component can also be controlled by controlling the printer to print a line that ranges from light and thin to heavy and thick. Similarly, the printer can be controlled to print a line that is narrower or wider. Further, the printer can be controlled to repeat the printing of a line directly on top of a previous line, thereby increasing the thickness. In some applications, it may be desirable to use the channel for separation techniques when the channel is located only on one substrate as shown in FIGS. 1A, 1B and 1C without a cover. In most applications, it will be desirable to affix a cover (now shown) in FIGS. 1A, 1B and 1C to the substrate 25 so that the component is sandwiched between the two substrates. Also, when two substrates are used, the component can be printed entirely on one of the substrates only or the component can be printed partially on one of the substrates and partially on another substrate. The two substrates can then be aligned with one another so that the channel is fully completed when the two substrates are affixed together with the component sandwiched in between. For example, one substrate could have component deposited thereon using print technology at a thickness of 100 micrometers and the other substrate could simply be used as a cover for the channel. Alternatively, the first substrate could have component printed thereon with a thickness of 50 micrometers and the second substrate could also have component printed thereon with a thickness of 50 micrometers. When the first substrate and second substrate are aligned with and affixed to one another with the components in between, the thickness of the component sandwiched between the two substrates will be 100 micrometers in both examples. In some applications, it may be desirable to create one line or part of one line on one substrate and the other line or part of the other line making up the channel on another substrate. In this example, the channel will not be fully formed until the two substrates are aligned with and affixed to one another.

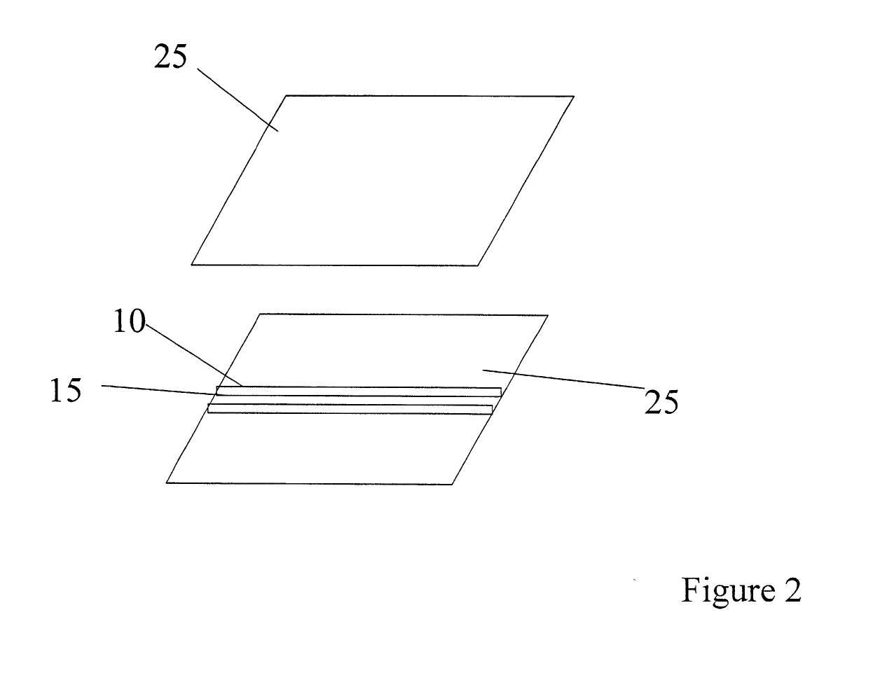

In FIG. 2, it can be seen that there is a first substrate 25 having two lines 10 of printed component printed thereon to define a channel 15 and a second substrate 25 located above the first substrate. The second substrate 25 can act as a cover only or the second substrate 25 can have identical lines printed on an underside (not shown) of the second substrate 25 that are aligned with the lines 10 when the two substrates are affixed to one another. Substrates can be affixed by various means including epoxy. It is important to ensure than no epoxy leaks into the channel as that would change the physical properties or dimensions of the channel. When the substrates shown in FIG. 2 are affixed to one another, the channel can then be used for whole column detection (WCD) isoelectric focusing.

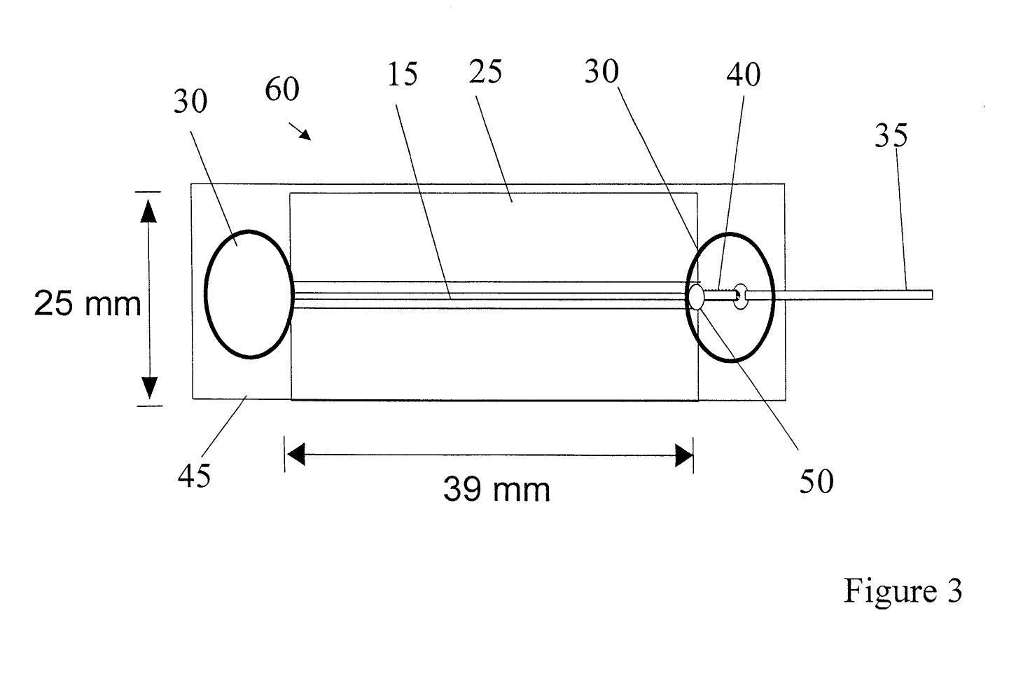

In FIG. 3, the cartridge from FIG. 2 including the two substrates 25 (only one of which is shown in FIG. 3) defining the channel 15 is attached to a glass microscope slide 45 with the transparent channel side aligned to the detection window of the IEF instrument (not shown). Electrolyte vials 30 are mounted at each end of the channel 30. A piece of hollow fiber membrane 40 connected to a piece of capillary 35 and channel 15 to facilitate sample injection at the end 50 and eliminate possible mixing of sample with electrolyte. At the other end of the channel 15, the electrolyte vial 30 is connected directly to the channel. The whole system including detection devices can be constructed using print technology as well. For example, the electrolyte vials could be printed on to the glass plate and substrate 25. The entire arrangement shown in FIG. 3 constitutes a cartridge 60.

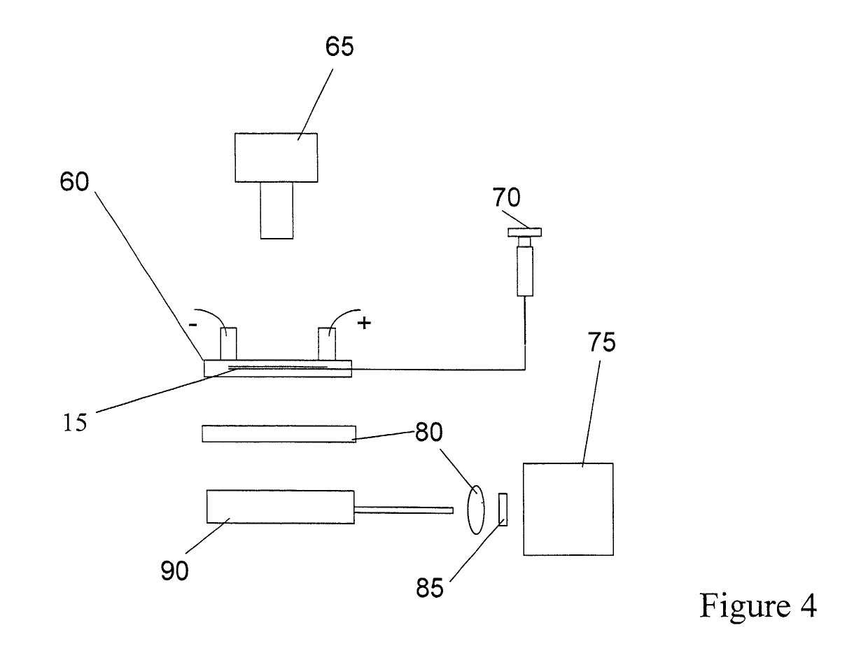

In FIG. 4, there is shown a schematic diagram of the instrument setup for the cartridge 60 when IEF is carried out using absorption imaging detection. The UV source 75 is an eighty watt Xe lamp with a 280 nm bandpass filter 85. The UV radiation is directed through a 280 nm filter 85, through a focusing lens 80 and into an optical fiber bundle 90, which directs the light through the focusing lens 80 on to the channel 15 within the cartridge 60. A CCD camera 65 was used as a detection sensor. The microchannel 15 was fixed in the optical path and samples were injected by pressure from a syringe 70 connected to one end of the channel 15. The arrangement shown in FIG. 4 is one detection arrangement only and various other detection arrangements are known and could be utilized with the microchannel of the present invention.

Various materials can be used for the printed component. For example, the printed component or “ink” can be polymeric material, mineral filled polymer, gel, glass forming substance or solid dissolved in solvent. All these materials will solidify after application onto the substrate forming printed component. Printed component can be a silicone coating and a particular silicone coating that was found to be satisfactory is a mineral filled, thermosetting modified silicone coating known as ESL 240-S-B (a trademark of Electro-Science Laboratories Inc.). Various other printed components can be used as well. It is advantageous to have a component that is chemically and electrically inert and will strongly adhere to the substrate. The substrate is also preferably chemically and electrically inert as well as being optically transparent as the substrate provides a detection window for the microchannel. Suitable substrates are glass plates and plastic sheets as well as quartz sheets. Acrylic substrates and cellulose acetate butyrate substrates as well as polyethylene sheets have been found to be satisfactory. While it will usually be desirable to choose a printed component that is non-conductive, in some applications, it may be beneficial to have a printed component that is conductive. For the purposes of the separation described in FIG. 4, the substrate must have good transparency at 280 nm in order for the detection means to operate properly. Even though the transparency of the 250 mm thick polyethylene sheet at 280 nm is suboptional, it can be used to demonstrate the principle of micro-channel IEF. In other uses, it may be desirable to have translucent or opaque substrate.

Surface modification is very important in IEF to eliminate electroosmatic flow (EOF) an interaction between analytes and the surface of the separation channel. Microchannels that are made from fused silica or quartz will have significant EOF because of the hydrolysis of surface silane groups. On the other hand, channels that are fabricated from plastic may have significant interaction with analytes owing to their hydrophobicities. Two kinds of surface modification methods are chemical modification and dynamic coating. With chemical modification, hydrophilic molecules are chemically bound to the surface of the fused silica or plastic channel. With dynamic coating, surfactant additives are added to the sample solution and dynamically bound to the surface of the capillary. Dynamic coating is commonly used in CIEF when plastic materials are used as columns or column coatings. Therefore, 0.25% methyl cellulose was added to the sample solution.

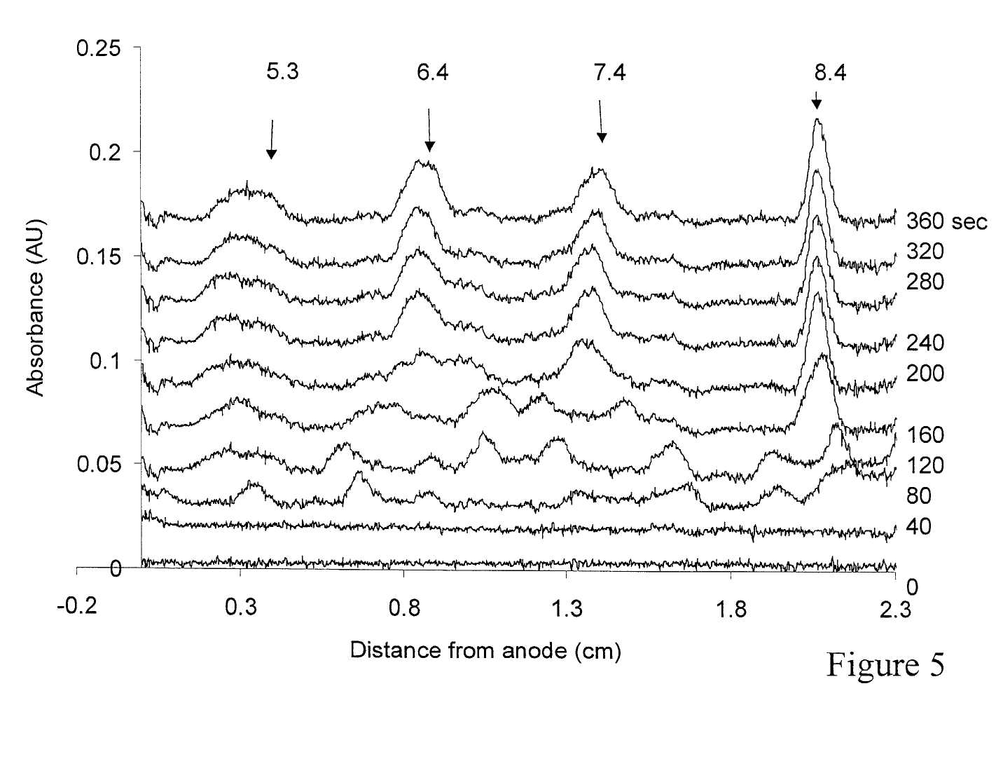

FIG. 5 presents the dynamic focusing of four small molecular mass pI markers (pI's: 5.3, 6.4, 7.4, and 8.4, all at concentration of 20 μg/ml) under electric field of 385 V/cm. 2% Bio-Lyte pH 3010 was present in the sample mixture. Catholyte was 20 mM NaOH, and anolyte was 20 mM H₃PO₄. The separation channel was conditioned by passing through 0.25% methyl cellulose for 30 minutes. The samples are mixed with MC (final concentration 0.25%). Upon application of the electric field, ampholytes migrate from both sides of the separation channel and converge into separated peaks within 3 minutes. FIG. 5 shows the unique IEF transit double peak phenomenon. The dynamic focusing process shown in FIG. 5 verifies that EOF is virtually eliminated for the 6-minute duration of the experiment by the methyl cellulose additive, since no cathodic drift can be seen. Peak broadening of the focused zones can be noticed in FIG. 5, however. This may result from the incomplete control of the interaction between ampholytes and the surface of the separation channel or the relatively low electric field present due to large dimensions of the separation channel. When a high electric field (770 V/cm) is applied, significant disturbance of IEF is noted due to higher EOF and convection flow, and poorly focused zones resulted. Reproducibility is improved under lower electric field (385 V/cm). Table 1 lists the reproducibilities of peak positions for the four pI markers separated at 385V/cm.

TABLE 1
Peak positions (pixel) of the four p1 markers from the anode in the
printed channel IEF microcartridge

| Run/pl | 5.3 | 6.4 | 7.4 | 8.4 |
|---|---|---|---|---|
| 1 | 694 | 894 | 1125 | 1399 |
| 2 | 673 | 911 | 1139 | 1410 |
| 3 | 690 | 895 | 1128 | 1415 |
| 4 | 688 | 900 | 1130 | 1414 |
| 5 | 678 | 906 | 1125 | 1407 |
| 6 | 665 | 885 | 1084 | 1384 |
| SD | 11.2 | 9.268 | 19.24 | 11.72 |
| Average | 681.3 | 898.5 | 1122 | 1405 |
| RSD (%) | 1.6 | 1.0 | 1.7 | 0.8 |

The data in Table 1 shown that RSD values within 1.8% were obtained for all four pI markers. Considering that this research is in its preliminary stage, the channel design, surface modification, and cartridge assembly have not yet been optimized; better results can be expected as a result of these optimizations.

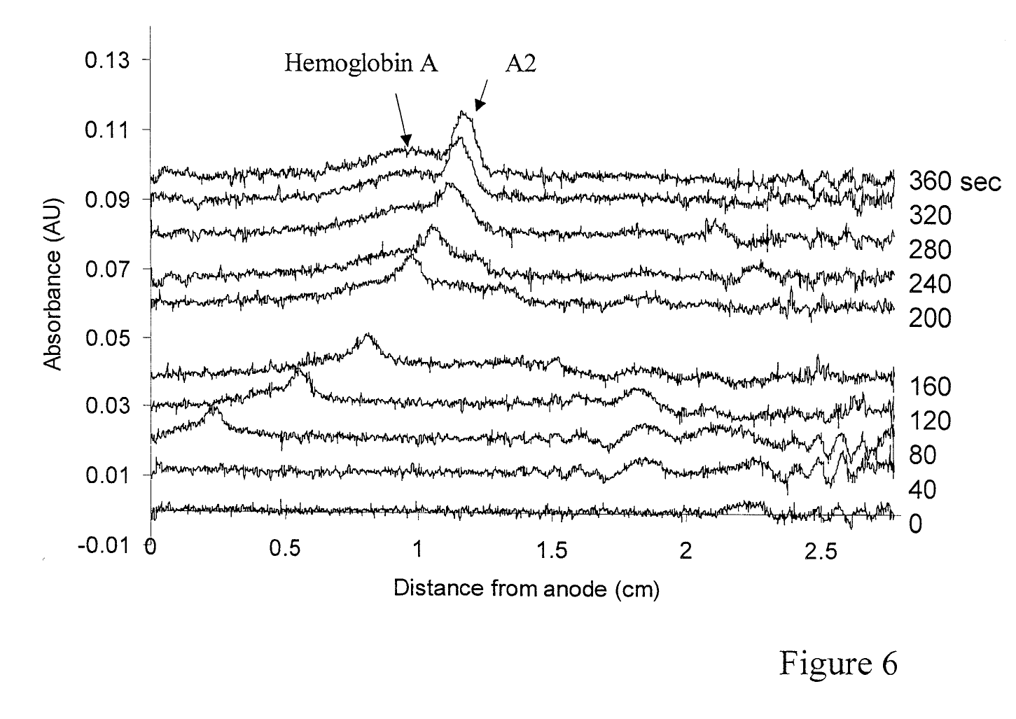

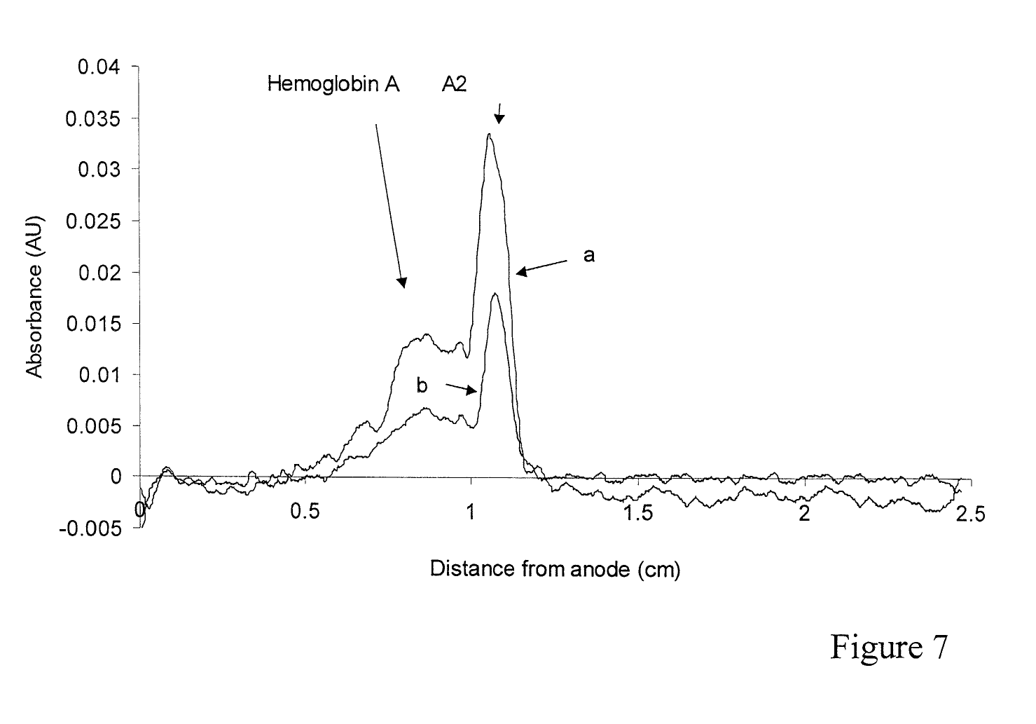

Having proven good separation and reproducibility for the low mass pI markers, the printed channel cartridge was used to demonstrate the separation of protein samples. FIG. 6 shows the dynamic focusing of hemoglobin control A, A₂ (pI: 7.0 and 7.4, respectively; at concentration of 250 μg/ml) under electric field of 385 V/cm. Other conditions were the same as those described with respect to FIG. 5. It can be seen from FIG. 6 that the hemoglobins are focused and separated within 5 minutes, although overlap is apparent because of peak broadening. The reduced resolution due to protein-surface interaction prevents the complete resolution of these proteins (pI difference of 0.4), suggesting the importance of optimization of the surface modification in later research. To confirm reproducibility and the quantitative determination capability of channel IEF, different concentration hemoglobin A, A₂ samples were analyzed. FIG. 7 illustrates the electropherograms obtained by focusing 250 and 500 μg/ml Hemoglobin A, A₂, respectively, under an electric field of 385 V/cm. The electropherogram in FIG. 7 shows that the peak positions of the hemoglobins are reproducible, and the peak areas are proportionally higher for the higher concentration sample.

Printed channel IEF has inherent advantages, such as low cost and ease of fabrication. The materials used to fabricate printed channel, such as polyethylene, cellulose acetate butyrate, and Teflon (a trade mark), are inexpensive and readily obtained. The procedures for channel printing and fabrication are simple. Other than epoxy glue bonding, heat sealing, lamination and laser welding are also possible methods for channel fabrication.

Peak broadening in printed channel IEF can be reduced by optimizations of channel design, material selection, and surface modification. One possible improvement in the separation channel is illustrated in FIG. 1B, where the dimensions of the channel 15 are much smaller than the width of the channel shown in FIG. 1A. In this design, the microchannel can be connected with the electrolyte vials directly with a hollow membrane in between, and sample can be injected into the channel through side injection channels. In this design, the risk of mixing the sample in the separation channel with electrolytes in electrolyte vials is reduced, and higher electric fields can be applied. Other materials such as acrylic and cellulose acetate butyrate plastic could be selected to fabricate the channels to provide better surface inertness to ampholytes and analytes. Chemical modification of the surface may also provide better modification than that of dynamic coatings.

The sensitivity for analyte detection in printed channel IEF may be improved by the selection of a better transparency channel material, an increase in the light path, and the use of fluorescence detection. The inherent transparency of the channel material at the detection wavelength and the thickness of the plastic substrate are important variables. The sensitivity can also be improved by increasing the light path through the separation channel. For example, the dimensions of the channel could be redesigned so that the larger dimension is the light path (i.e. the 1 mm dimension instead of the 0.10 mm one) to improve the detection sensitivity.

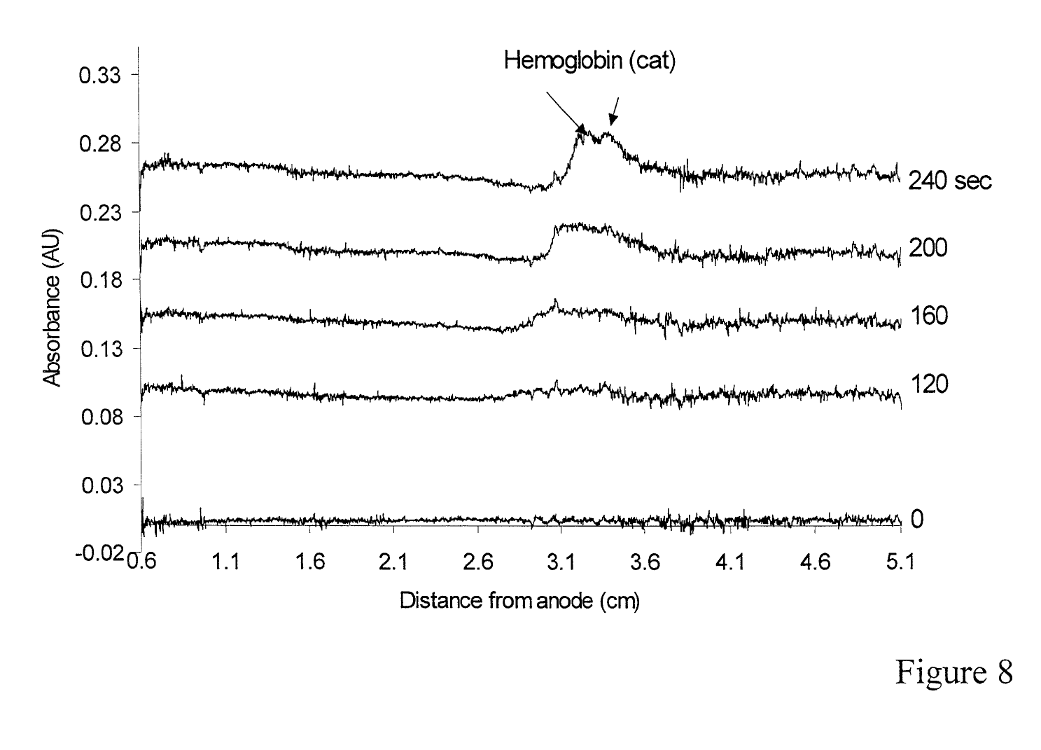

The focusing experiment can be produced without carrier ampholytes by using tapered channel with appropriate buffer. A tapered channel cartridge with a length of 60 mm, a thickness of 0.2 mm and a width at the narrow and wide ends of 0.2 mm and 2 mm respectively was used to form a pH gradient in Tris-HCl buffer. Because of the difference in cross sectional area, the resistance of the medium of the narrow end of the channel is higher than that of the wide end. Therefore, the temperature of the buffer is higher in the narrow end resulting in a narrow pH gradient formed in this channel filled with Tris-HCl buffer because of the high temperature effects on pH of this buffer. FIG. 8 shows the electropherograms for the dynamic focusing of 250 μg/ml cat hemoglobin in 25 mM pH 7.06 Tris-HCl buffer. It can be seen that the cat hemoglobin begins to be focused in two minutes and accumulates into two larger peaks in four minutes.

It can be seen that the microchannels created by the present invention provide good qualitative and quantitative results for low molecular weight pI marker as well as protein samples.

In constructing a microchannel in accordance with the present invention, the substrate or substrates are first clean with ethanol and baked at 80° C. in a convection oven and placed into the screen printer. The polymeric ink was applied to the screen surface and printed on the substrate surface. After the polymeric strips had been applied (with a desired thickness of 50 μm), the printed substrate was cured immediately overnight at 93° C.

The screen printer, which was designed for printing circuit boards, was the DEK model 248 semiautomatic screen printer from DEK USA Inc. (Flemington, N.J.). A vacuum tooling plate attachment with nine hundred 2 mm diameter openings was custom designed by DEK to hold flexible substrates such as thin plastic sheets in place during the printing process. The screen patterns were designed in house and were fabricated by Hybrid Integrated Service Inc. of Mississauga, Ontario, Canada. The size of the screen was 508×508 mm of internal dimension. Considering two parallel strips with a distance of 1 mm as a sub unit, 80 of these units can be printed per printing.

Polyethylene sheet, with a thickness of 0.25 mm, was purchased from Cadillac Plastic (London, ON, Canada). The polymer protective silicone coating ESL 240-SB was received as a gift from Electro-Science Laboratories, Inc. (King of Prussia, Pa.). Five-minute epoxy syringe glue was obtained from LePage (Brampton, ON, Canada). Capillary of 183 μm ID, 342 μm OD (TSP 180350) was purchased from Polymicro Technologies Inc. (Phoenix Ariz. Microporous hollow fiber with pore size of 0.03 μm and 383.3 μm ID was obtained from Hoechst Celanese (Frankfurt, Gemany). Human hemoglobin control A, A₂ (pIs, 7.0 and 7.4, respectively) was purchased from Helena Laboratories (Beaumont, Tex.). BioMark synthetic pI markers were obtained from Bio-Rad (Mississauga, ON, Canada). Methylcellulose (MC, 4000 cp for a 2% solution) and Pharmalyte of pH 3-10 were obtained from Sigma ( St. Louse, Mo.) and were of analytical grade. Water was purified using an ultra-pure water system (Barnstead/Thermolyne, Dubuque, Iowa) and was used for all solutions.

MC solution of 0.25% is used to condition the separation capillary and is added to the sample to eliminate EOF and protein adsorption. The sample is prepared by dissolving the proteins in a 0.25% methyl cellulose solution to the desired concentration and injected into the separation column. After sample injection, the electrolyte vial is rinsed with water three times, and is filled with catholyte (sodium hydroxide solution) and anolyte (phosphoric acid solution), respectively. DC power is applied after 30 seconds of sample injection to allow the balance of sample inside the channel, and data is collected at 40 second interval to monitor the focusing process. The separation channel is rinsed with 0.25% MC between analysis for better reproducibility.

I claim:

1. A microchannel for use for separating two or more substances present in a sample, said channel comprising a first substrate and a second substrate with printed component printed on at least one of said substrates in a shape to define a perimeter of said channel, said substrates being affixed to one another so that said component is sandwiched between said substrates and is in contact with both substrates.

2. A channel as claimed in claim 1 wherein said printed component is in sealing contact with both substrates.

3. A channel as claimed in claim 2 wherein there is no etching required and no pre forming of the substrates to include a channel during manufacture required.

4. A channel as claimed in claim 1 wherein a first part of said component is printed on said first substrate and a second part of said component is printed on said second substrate, said parts of said component together forming a channel when said substrates are affixed to one another.

5. A channel as claimed in claim 4 wherein said substrates are affixed to one another with said first part of said component on the first substrate is aligned with said second part of said component on said second substrate.

6. A channel as claimed in claim 5 wherein said substrates are affixed to one another with the component on the first substrate in contact with the component on the second substrate.

7. A channel as claimed in claim 1 wherein said component is printed on said first substrate, said second substrate being arranged to provide a cover for said channel.

8. A channel as claimed in any one of claims 1, 4 or 7 wherein said component is one of the following materials: polymeric material, mineral filled polymer, gel, glass forming substance or solid dissolved or suspended in solvent.

9. A channel as claimed in any one of claims 1, 4 or 7 wherein said component is a mineral filled, thermosetting modified silicone coating.

10. A channel as claimed in any one of claims 1, 4 or 7 wherein said substrates, or either of them, are one of transparent, translucent and opaque.

11. A channel as claimed in any on of claims 1, 4 or 7 wherein said substrates, or either of them, are one of transparent, translucent and opaque and are formed from glass, quartz or plastic.

12. A channel as claimed in claim 1 wherein said substrates are affixed to one another by epoxy.

13. A channel as claimed in claim 12 wherein there is no epoxy located within the channel.

14. A channel as claimed in claim 1 wherein said channel has side walls formed by the component that are parallel to one another.

15. A channel as claimed in claim 14 wherein said side walls are straight.

16. A channel as claimed in claim 1 wherein said channel has elongated side walls formed by said component that are tapered relative to one another.

17. A channel as claimed in claim 1 wherein said substrates are polyethylene sheets.

18. A channel as claimed in claim 6 wherein said component is printed with a thickness of least 50 micrometers.

19. A channel as claimed in any one of claims 1, 4 or 7 wherein said perimeter of the channel has a width of approximately 100 micrometers.

20. A channel as claimed in claim 7 wherein the component printed on the substrate has a thickness of approximately 100 micrometers.

21. A channel as claimed in any one of claims 1, 4 or 7 wherein said component is conductive or non-conductive.

22. A channel as claimed in any one of claims 1, 4 or 7 wherein said component is chemically and electrically inert.

23. A channel as claimed in any one of claims 1, 4 or 7 wherein there are means to subject the channel to an electric field.

24. A channel as claimed in any one of claims 1, 4 or 7 wherein said channel has two ends and there is one electrolyte vial directly connected to each end.

25. A channel as claimed in any one of claims 1, 4 or 7 wherein said channel has an entrance located therein, said entrance being suitable to inject a sample into the channel for isoelectric focusing.

26. A channel as claimed in any one of claims 1, 4 or 7 wherein said substrates are made from a material selected from the group of glass, acrylic, cellulose acetate butyrate and polyethylene.

27. A channel as claimed in any one of claims 1, 4 or 7 wherein there are means to pass light through the entire channel to permit whole column imaging detection.

28. A channel as claimed in any one of claims 1, 4 or 7 wherein the substrates are transparent and there are means to pass light through the entire channel to prevent whole column imaging detection.

29. A microchannel for use for separating two or more substances present in a sample, said channel comprising a first substrate with printed component printed on said first substrate in a shape to define a perimeter of said channel, there being no etching required.

30. A method of constructing a microchannel that is suitable for use for separating two or more substances present in a sample, said channel having a first substrate and a second substrate, said method comprising cleaning the substrates, printing a channel on at least one of said substrates using printing techniques depositing a printed component in the shape of a perimeter of a channel on said at least one of said substrates, curing said at least one of said substrates and affixing said substrates to one another with said component sandwiched between said substrates.

31. A method of constructing a microchannel as claimed in claim 30 wherein said component is deposited by at least one of inkjet printing and screen printing.

32. A method of constructing a microchannel as claimed in claim 31 including the step of using the channel to carry out isoelectric focusing.

33. A method of constructing a microchannel that is suitable for use for separating of two or more substances present in a sample, said channel having a first substrate and a cover for said substrate, said method comprising cleaning the substrate, printing a channel on said substrate using printing techniques for depositing a printed component in the shape of a perimeter of said channel on said first substrate and curing said first substrate, affixing said cover to said substrate with said channel sandwiched between said first substrate and said cover.

34. A method of constructing a microchannel that is suitable for use for separating two or more substances present in a sample, said channel having a first substrate, said method comprising cleaning said first substrate, printing a channel on said first substrate using printing techniques by depositing a printed component in the shape of a perimeter of a channel on said first substrate and curing said first substrate.
